(19) United States
(12) Patent Application Publication
(10) Pub. No.: US 2026/0196692 A1
(43) Pub. Date: Jul. 9, 2026

(54) Protection Device For A Battery Pack

(71) Applicant: LYTEN SWEDEN AB, Stockholm (SE)

(72) Inventors: Zoran Stanisic, Täby (SE); Surajit Midya, Täby (SE)

(21) Appl. No.: 19/133,964

(22) PCT Filed: Nov. 28, 2023
(86) PCT No.: PCT/EP2023/083384

§ 371 Date: May 29, 2025

(30) Foreign Application Priority Data
Nov. 30, 2022 (SE) 2251395-6

(51) Int. Cl. H01M 50/583; H01M 50/502; H01M 50/588; H01M 50/59

(52) U.S. Cl. CPC H01M 50/583; H01M 50/502; H01M 50/588; H01M 50/59; H01M 2200/103

(57) ABSTRACT

There is disclosed herein a protection device (100) for a battery pack, and a battery pack (800) comprising such a protection device (100). The protection device (100) comprises a fuse (102) arranged in a space (103) between electrical conductors (104) and configured to weaken when an 5 overcurrent passes therethrough. According to a beneficial aspect of the present disclosure, the protection device (100) comprises an insulator (106) formed as a resilient member having a biased state and a relaxed state. The insulator (106) is held in the biased state by the fuse (102) and is biased towards the space (103) between the electrical conductors (104) in the biased 10 state.

### TECHNICAL FIELD

The present disclosure relates to a protection device for a battery pack and a battery pack comprising such a protection device.

### BACKGROUND

In addressing climate change there is an increasing demand for rechargeable batteries, e.g., to enable electrification of transportation and to supplement renewable energy. Battery cells may be arranged into battery modules and connected in series and/or parallel within battery modules. Battery modules may be arranged into battery packs and connected in series and/or parallel within battery packs. Battery packs may be adapted for installation into electric vehicles.

During operation of battery packs, e.g., in an electrical vehicle or in other applications, there may be a desire to isolate the various components of the battery pack, e.g., isolating battery cells or battery modules from each other, for example in the event of faults, failures, etc., or isolating a battery pack from the electrical load drawing from the battery pack. Such isolation is conventionally achieved using fuses arranged between electrical conductors.

Fuses are components of electrical protection devices that operate to provide overcurrent protection for electrical systems. Fuses typically comprise a metal wire, strip, or filament, a solder connection, or the like, which may be referred to as a fuse element, that melts or fractures when too much current (i.e., an overcurrent) flows through it, thereby interrupting the current flow between the electrical conductors between which the fuse is installed. Such an operation may commonly be referred to as ‘blowing’ the fuse.

In the event of a fault or failure, causing an overcurrent that blows the fuse, an arc may persist across the electrical conductors between which the fuse was arranged. The response time of the fuse may be considered as having two stages: a first stage where the fuse blows (i.e., for the fuse element to melt or fracture) and a second stage where the arc extinguishes.

### SUMMARY

It is realized as a part of the present disclosure that an improvement in the isolation provided by a protection device comprising a fuse may allow for an increased voltage across said protection device, without an associated increase in the time taken to extinguish the arc across the electrical conductors between which the fuse was arranged. According to aspects of the present disclosure, the improved isolation is provided by the arrangement of an insulator between the electrical conductors after the fuse has blown.

In particular, according to an aspect of the present disclosure, there is provided a protection device for a battery pack, comprising a fuse arranged in a space between electrical conductors and configured to weaken when an overcurrent (i.e., a current higher than a threshold current) passes through the fuse. The fuse may be configured such that a current passing therethrough is deemed to be an ‘overcurrent’ if it exceeds a threshold corresponding to a fault or failure on either side of the electrical conductors.

For example, the fuse may comprise a fuse element configured to melt or fracture when an overcurrent passes therethrough, such as a metal wire or strip. In some examples, the fuse may consist of such a fuse element, or the fuse may comprise a casing or holder for the fuse element to improve the structural resilience thereof. In an example, the fuse may consist of a fuse element being a strip of aluminum metal. The strip of aluminum metal may be dimensioned so as to melt and thereby interrupt a current flowing therethrough when the current exceeds a threshold current, in a manner that will be understood by those skilled in the art.

In the present disclosure, the fuse may preferably be suitable for installation into a high-voltage battery pack. As such, it may be expected for the fuse to withstand a current of at least 200 Å, for example, or at least 1.5 KA, in some examples. The voltage across the electrical conductors (e.g., busbars connecting battery modules within a battery pack) may be expected to be 1.5 kV or more. In such high current and high voltage environments, the reliable solution described herein is particularly beneficial.

According to an advantageous aspect of the present disclosure, the protection device further comprises an insulator formed as a resilient member having a biased state and a relaxed state, wherein the insulator is held in the biased state by the fuse, and the insulator is biased towards the space between the electrical conductors in the biased state.

Accordingly, in the event of an overcurrent, the fuse can be weakened (e.g., melt or fracture) and thereby cease holding the insulator in its biased state and allow the insulator to move into the space between the electrical conductors.

As discussed above, a current interrupting operation performed by a fuse may be considered as having two main stages, wherein the current is interrupted, i.e., a current path between the electrical conductors is removed, and then an electrical arc between the electrical conductors is extinguished. According to the presently disclosed approach, the time taken for each of these stages to occur is advantageously reduced.

That is, as the insulator is held in the biased state by the fuse, a tension is applied to the fuse by the insulator such that, as soon as the fuse is sufficiently weakened by an overcurrent, the displacement of the fuse from the space between the electrical connections is encouraged by the resilient return of the insulator to its relaxed state. Therefore, the current path can be interrupted more rapidly in the event of an overcurrent.

Moreover, once the fuse has blown, the insulator moves into, and substantially remains in, the space between the electrical conductors. Therefore, the ability for an electrical arc to persist between the electrical conductors is significantly reduced. It will be appreciated that the dimensions and material properties of the insulator may be selected based on an expected voltage between the electrical conductors and thus the required level of arc inhibition.

Nonetheless it will be appreciated that the introduction of a protection device according to the present disclosure may allow for an increase in voltage between the electrical conductors without substantially modifying the surrounding components. That is, an insulator as described above may, in some cases, be retrofitted into existing systems and thereby allow such systems to increase their operating voltages without an accompanying risk of failure of the protection device, such as an excessive persistence of an electrical arc across the electrical conductors.

Furthermore, by using an insulator that itself is formed as a resilient member, wherein the relaxed state of the resilient member is arranged in the space between the conductors, the effective ‘neutral’ state of the system (i.e., where the protection device has activated and relieved the elastic potential energy of the insulator formed as a resilient member) is a state where a system has been rendered safe. Put another way, the resilient member being biased towards the space between the conductors allows for a ‘triggered’ state wherein the insulator is reliably held in this space between the conductors, thereby ensuring that the system remains safe for a substantial time after said triggering of the protection device. This may allow the system to be delivered to a safe location for repair or replacement. A ‘safe’ location in this context may be an environment with controlled ambient and/or climate conditions, and/or with appropriate safety measures such as wearing protective clothing, as battery packs can have high energy densities and thus be hazardous to open, especially if damaged.

According to an aspect of the present disclosure, the protection device may be incorporated into a battery pack, such as a battery pack for an automotive vehicle, or as part of an electrical energy storage system. According to this aspect, the battery pack comprises at least two battery modules, and the protection device is connected such that the electrical conductors and the fuse form an electrical interconnection between the at least two modules.

In such a battery pack, and further to the above discussion, the operational voltage of the battery modules may advantageously be increased as a consequence of the introduction of the protection device according to the present disclosure. Therefore, the energy density of the battery pack may be improved, and fault isolation within the battery pack may be improved.

The installation and maintenance of such a protection device may be made particularly simple, in the context of a battery pack, where the protection device is installed between busbars that interconnect battery modules within said battery pack. In this way, the casing of the battery pack serves to protect the protection device, but no further casing is required to surround the protection device. That is, within the casing of the battery pack, the protection device may be readily visible for inspection when installed on the busbars between battery modules. In this way, it can be readily verified that the protection device has activated as intended, and thus it can be verified that the battery pack has been rendered safe for further disassembly.

According to aspects of the present disclosure, the insulator has qualities of electrical insulation and elasticity, i.e., bending elasticity, (to thereby provide resilience) in at least one degree of motion (i.e., so that it can be biased towards the space between the electrical conductors). The insulator may also preferably be configured to withstand the temperatures that the fuse is expected to reach during an overcurrent. Such a configuration may be achieved through the addition of protective layers, coatings, or shielding, or by the choice of material from which the insulator is formed. For example, the insulator may be formed of a material such as mica, a glass-fiber-impregnated silicon-based material, etc.

It will be appreciated that, as the insulator itself is formed as a resilient member, no further component is required to bias the insulator towards the space between the electrical conductors. Accordingly, an advantageously simple protection device is provided with few moving parts and few interconnections between parts. Such simplicity thus not only improves the ease of manufacture of the protection device, but may also reduce the risk of failure of the protection device and, hence, forming the insulator as a resilient member may further advantageously improve the reliability of the protection device.

In one example a bi-metallic strip may form part of the insulator, e.g., as an integral addition or arranged thereon. The bi-metallic strip may heat up during an overcurrent (due to Ohmic heating) and thereby bend in a manner understood by those skilled in the art. This bending may thus contribute to the force applied by the insulator, formed as a resilient member, in urging the fuse out from its connection between the electrical conductors. In another example, the fuse element may be formed itself as a bi-metallic strip, such that an overcurrent thereacross causes the fuse element to deform and thereby break the connection between the electrical conductors, allowing the protection device to intervene, close, and insulate the space between the electrical conductors.

The insulator may have any suitable shape such that at least a part of the insulator can be arranged in the space between the electrical conductors when in the relaxed state, to inhibit an electrical arc therebetween. For example, the protection device may be formed as a flexible strip. Such a form for the insulator may advantageously improve the ease by which the insulator can be manufactured. For example, a sheet of material from which the insulator is to be formed may be readily cut or otherwise made into strips. Therefore, the ease of manufacture of the protection device may be further improved.

According to an example, a first end of the flexible strip may be fixed to a first electrical conductor of the electrical conductors and a second end of the flexible strip may be biased towards the first end by the fuse to thereby hold the insulator in the biased state. That is, a relaxed state for the flexible strip may be a state in which the flexible strip is substantially flat, and a biased state for the flexible strip may be a state in which the flexible strip is bent in on itself so as to move its ends towards each other, which may cause a curve or buckle to form in the insulator formed as a flexible strip.

The first end of the flexible strip may be fixed to the first electrical conductor by any suitable means, considering a preferred requirement of temperature resistance, electrical insulation, and reliable performance. For example, the flexible strip may be adhered to the electrical conductor by an adhesive. In some examples, an intermediate component, which may be referred to as an insulator mount or simply ‘mount’, may be fixed to the electrical conductor and the flexible strip may be affixed to said intermediate component.

Additionally or alternatively, the electrical conductor may be configured for attachment or fixing to the insulator. For example, if the insulator is formed as a flexible strip, the electrical conductor may have a flange or ridge arranged substantially proximate to the space between the electrical conductors, and extending away from the fuse. A first end of the flexible strip may then be fixed to this flange such that the insulator is held in the biased state by the fuse.

In some examples, the flexible strip may comprise a plurality of layers. The layers may be integrally formed such as during an injection molding or overlay molding process, or the layers may be separately formed and attached to each other thereafter.

Each layer may be made from the same material, and the number of layers may be tuned or selected according to a desired level of electrical insulation, resilience/elasticity, etc. Therefore, a highly adaptable and reparable protection device may be provided, wherein layers can be added or removed with ease according to, for example, an extent of their wear or decay, an expected increase in voltage across the electrical conductors, or other factors.

Alternatively, one or more layers may be made from a different material than another layer. For example, a first layer may provide more resilience than a second layer, and the second layer may provide more electrical insulation than the first layer, but the combination of both layers may provide an optimum level of resilience and electrical insulation. Accordingly, it may not be required to identify a single material that fulfills all of the desired properties for the insulator. It will be appreciated that, even if such a single material could be identified, a combination of materials may be preferred if the materials comprised in said combination are more cost-effective, more recyclable, or the like.

The level of insulation after the fuse has blown may further be enhanced by the use of multiple insulators that are held in a biased state by the fuse. That is, according to some examples the protection device may further comprise a second insulator formed as a resilient member having a biased state and a relaxed state, wherein the second insulator is held in the biased state by the fuse, and the second insulator is biased towards the space between the electrical conductors in the biased state.

Such an arrangement may further advantageously provide a level of redundancy such that, if one of the insulators does not behave as expected (e.g., it is dislodged or damaged) then another insulator may nonetheless be moved into the space between the electrical conductors to more rapidly extinguish any electrical arc therebetween. As a consequence, a more reliable protection device is provided according to such an arrangement having a second insulator.

The second insulator may be arranged at a same end/a same side or a different end/side as the other insulator. Put another way, the first insulator may be arranged at a first electrical conductor of the electrical conductors, and the second insulator may be arranged either also at the first electrical conductor, or at a second electrical conductor of the electrical conductors. By arranging the second insulator at the second electrical conductor, redundancy may be further enhanced as, for example, a risk of the insulators interfering with each other's operation may be advantageously reduced. Moreover, any localized fault preventing the proper operation of one of the insulators may not affect the other insulator if it is sufficiently localized.

It will be appreciated that, if the fuse (or the fuse element thereof) is not entirely destroyed (e.g., vaporized) by the overcurrent, then some fuse material may remain in the space immediately after the fuse has blown. It is to be expected that this fuse material will move under the action of gravity away from the space between the electrical conductors. Therefore, it may be preferred that there is a region below the fuse for such fuse material to move into. If some fuse material (being conductive) remains in this space, the risk of an electrical arc persisting across the electrical conductors may be increased.

Accordingly, in some examples, the (first) insulator and the second insulator may be collectively configured to rotate the weakened fuse. Therefore, the ends of the fuse may be more quickly separated and spaced from the respective ends of the electrical conductors to which they were coupled. Thus, an electrical arc between the electrical conductors may be more quickly extinguished.

In an example implementation, the (first) insulator may be biased in a first direction towards the space between the electrical conductors, and the second insulator may be biased in a second direction towards the space, the second direction being at least partially opposite the first direction. As the first and second insulators are arranged on opposite sides of the fuse, the application of at least partially opposing forces at opposite sides may readily encourage the rotation of the fuse from its position in the space between the electrical conductors.

In order to further accelerate the extinguishing of the electrical arc, the insulator may be further configured to remove at least a portion of the weakened fuse from the space between the electrical conductors when moving from the biased state to the relaxed state. For example, the insulator may be sized, shaped and/or arranged in such a way as to perform a ‘sweeping’ action across at least a part of the space between the electrical conductors, when moving from the biased state to the relaxed state (i.e., when an overcurrent has sufficiently weakened the fuse as to no longer hold the insulator in the biased state). Therefore, it can be reliably ensured that fuse material is quickly removed from the space between the electrical conductors.

In a further example, an end of at least one of the electrical conductors proximate to the space between the electrical conductors may have an insulating covering. The insulating covering may be made of the same material as the insulator, or a different material, depending on the implementation. The ends of the electrical conductors may have exposed and/or sharp edges between which electrical arcs may readily form and, thus, by covering these ends, the risk and severity of an electrical arc forming may be further reduced. In some examples, the insulator may be integrally formed with the insulating covering.

According to a refinement of this example, the fuse may pass through an opening in the insulating covering, and the insulator may be configured to, in the relaxed state, cover said opening in the insulating covering. Therefore, once the fuse has blown, the end of the electrical conductor(s) may present an entirely electrically insulated area, thus increasing the distance between exposed conductive portions and thereby further reducing the risk of an electrical arc persisting between the electrical conductors.

In preferred embodiments of the present disclosure, the electrical conductors may be covered in an insulating material so as to distance the closest exposed/conductive surfaces on each electrical conductor by a predetermined distance, corresponding to an insulation distance for a maximum expected voltage between the conductors. The closest exposed surface presented by the electrical conductors may thus be that to which the fuse is attached. Hence, when the insulator, formed as a resilient member, is moved into the space between the electrical conductors, the exposed surface is entirely covered, and the risk of arcing between the conductors is reduced, even in a case where a maximum expected voltage between the conductors is applied.

The fuse may preferably be formed with a more compact cross-sectional area, such as that conforming to a square or circle, while still also performing effectively as a fuse in terms of cross-sectional area. By making the cross-sectional profile more compact, a small insulator can be used to cover the (smaller) hole left in the insulating covering when the fuse is blown.

In these cases, a distance between the electrical conductors may be reduced, allowing for a more compact installation, and a shorter fuse. In some examples, the fuse may be integrated into the electrical conductors. For example, the electrical conductors (e.g., busbars) may be thinned, drilled, or otherwise reduced in cross-sectional area so as to form an effective fuse region between effective non-fuse regions.

It will be appreciated that a preferred arrangement of the electrical conductors is one wherein the fuse bridges the closest approach of the electrical conductors. Accordingly, the maximal risk of arcing is in the vicinity of the protection device and not elsewhere between the electrical conductors.

In some examples, the protection device may further comprise a further resilient member configured to bias the insulator towards the space between the electrical conductors. The further resilient member may comprise a spring (e.g., a coil spring, leaf spring, or the like), a compressive resilient material, and/or the like. In some further examples, additional force may be provided by a weight that is held in place by the fuse and/or the insulator.

Accordingly, it can be more reliably ensured that, in the event of an overcurrent, the weakened fuse is removed from the space between the electrical conductors and thus the insulator is allowed to adopt the relaxed state, i.e., occupying said space between the electrical conductors. Such an additional/further resilient member may be preferred if the resilience of the insulator may be insufficient on its own to reliably dislodge the weakened fuse and/or cause the insulator to adopt its relaxed state.

In a preferred embodiment, the further resilient member may comprise a spring substantially formed of aluminum oxide. Aluminum oxide advantageously may withstand the higher temperatures expected in a protection device such as that described above, without losing its resilience. Moreover, aluminum oxide is advantageously inexpensive and easy to manufacture with.

In any event, numerous advantages, some of which are described above, may be realized through the implementation of such an improved protection device. These advantages, as well as others, may be further appreciated through a description of specific illustrated embodiments.

### BRIEF DESCRIPTION OF THE DRAWINGS

Aspects of the present disclosure will be described, by way of example only, and with reference to the following figures, in which:

FIG. 1A schematically shows a side view of a protection device according to an aspect of the present disclosure, before and after a melting of the fuse;

FIG. 1B schematically shows a top view of the protection device shown in FIG. 1A;

FIGS. 2 to 8A-D schematically show various views of protection devices according to example implementations of the present disclosure; and

FIG. 9 schematically shows a battery pack comprising battery modules, according to an aspect of the present disclosure.

### DETAILED DESCRIPTION

The present disclosure is described in the following by way of a number of illustrative examples. It will be appreciated that these examples are provided for illustration and explanation only and are not intended to be limiting on the scope of the disclosure.

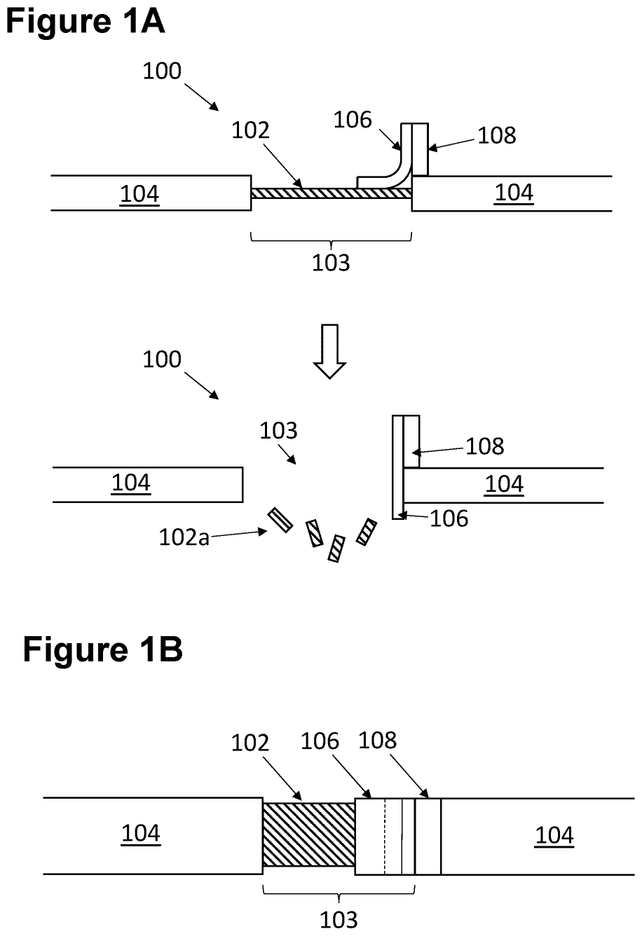

FIG. 1A schematically shows a side view of an example protection device 100, according to an aspect of the present disclosure. FIG. 1B shows a top view of the same protection device 100. The upper and lower portions of FIG. 1A show the protection device 100 before and after an overcurrent has occurred, respectively.

The protection device 100 comprises a fuse 102 arranged in a space 103 between electrical conductors 104. In the illustrated example, the fuse 102 consists of a fuse element being a strip of metal (e.g., aluminum). As shown in the lower portion of FIG. 1A, when an overcurrent passes through the fuse 102, it is caused to melt into pieces of fuse material 102a.

In some examples, the fuse 102 entirely vaporizes so as to leave no fuse material 102a behind. In further examples, the fuse 102 is attached to the electrical conductors 104 by weaker attachment points such that these attachment points are the first part of the fuse 102 to entirely melt and thus the fuse 102 may more rapidly separate from the electrical conductors 104.

The protection device further comprises an insulator 106 formed as a resilient member. In this example, the insulator 106 is a flexible strip. A first end of the insulator 106 is attached to one of the electrical conductors 104 via a mount 108. The mount 108 may also be made of an electrically insulating material. It will be appreciated that, in some other examples, the mount 108 may be an integrally formed part of the electrical conductor 104 or the insulator 106. The second end of the insulator 106 abuts the fuse 102 and the insulator 106 is thereby held in a biased state wherein the second end is biased (i.e., bent or flexed) towards the first end.

As shown in the upper portion of FIG. 1A, when the insulator 106 is in the biased state, it is biased (i.e., rotationally biased) towards the space 103 between the electrical conductors 104. Therefore, as shown in the lower portion of FIG. 1A, when an overcurrent passes through the fuse 102 and is caused to be weakened thereby (i.e., melting), the insulator 106 is no longer held in the biased state by the fuse 102. Thus, the insulator 106 moves under elastic action from the biased state to a relaxed state, which in this case is when the insulator 106 is straight.

In the relaxed state, the insulator 106 is arranged in the space 103 between the electrical conductors 104. Therefore, an electrical arc between the electrical conductors 104 is advantageously inhibited. It will be further appreciated that the forming of the insulator 106 itself as a resilient member, and the holding thereof in a biased state by the fuse 102, may allow for the insulator 106 to assist in the removal of the fuse material 102a (i.e., the weakened fuse 102) from the space 103 between the electrical conductors 104. Accordingly, the blowing of the fuse 102 in the event of an overcurrent may be made faster and more reliable.

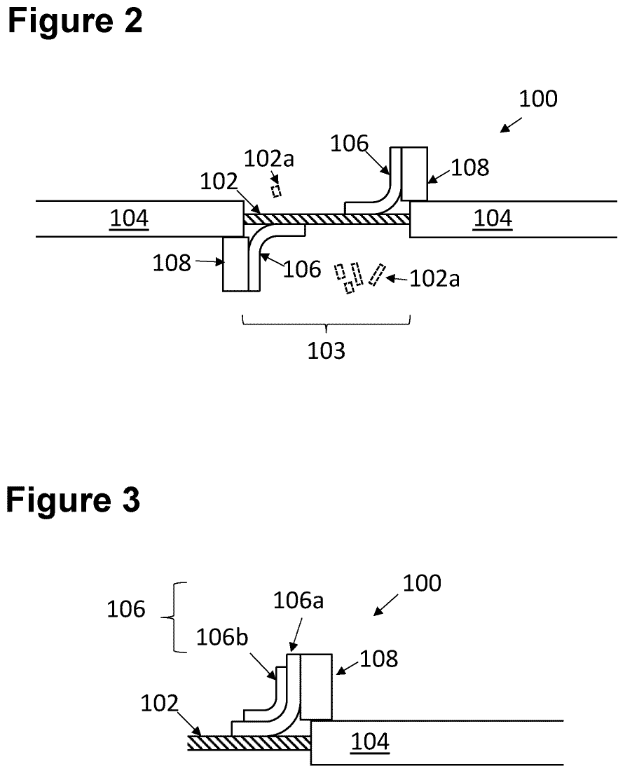

FIG. 2 shows another example protection device 100, having like-numbered components substantially corresponding at least in their function to those discussed above in relation to FIGS. 1A and 1B.

The protection device 100 shown in FIG. 2 comprises two insulators 106. It may be assumed for the present description that the insulators 106 are identical in their manufacture and differ only in their installation. However, it will be appreciated that each insulator 106 may be made from a different material, a different shape or thickness of a same material, or have an entirely different construction, depending on the implementation.

One insulator 106 is arranged at each end of the fuse 102. That is, one insulator 106 is arranged on a respective mount 108 at each of the electrical conductors 104. Furthermore, one insulator 106 is arranged (i.e., on a mount 108) on a top side of an electrical conductor 104, while the other insulator 106 is arranged on a bottom side of the other electrical conductor 104.

Accordingly, while both insulators are biased toward the space 103 between the electrical conductors 104, the forces applied by the insulators 106 at either end of the fuse 102 are opposed (or at least partially) to each other. That is, a first insulator 106 is biased in a first direction towards the space 103 between the electrical conductors 104, and a second insulator 106 is biased in a second direction towards the space 103, the second direction being at least partially opposite the first direction.

Therefore, it can be seen that the insulators 106 are collectively configured to expel (parts of) the weakened fuse 102a (shown in dotted lines). Moreover, the opposing movements of the insulators 106 causes the potential ‘gap’ through which arcing could occur to close twice as quickly as when a single insulator 106 is used. Furthermore, the enhanced shear force applied by the opposed insulators 106 may advantageously assist with the breaking/detachment of the weakened (e.g., molten) fuse.

Therefore, it will be appreciated that the provision of two insulators 106 may advantageously provide a means for rapidly decoupling and distancing the ends of the fuse 102 from the electrical conductors 104, thereby decreasing the time taken for the fuse 102 to blow (i.e., for the fuse 102 to be weakened and the weakened fuse 102a to be removed from the space 103), but also further impeding the formation of an electrical arc across the electrical conductors 104.

It will be further appreciated that the installation of multiple insulators 106 may advantageously provide redundancy to a protection device 100 and thereby improve the reliability of the operation thereof. Moreover, the insulation properties of the protection device 100 may be further enhanced by providing more insulating material in the space 103 between the electrical conductors 104 when the insulators 106 are in their relaxed states.

In some examples, further insulators 106 may be installed, or the second insulator 106 may be installed at a different location, such as all insulators 106 being on a same side, and/or at a same end of the fuse 102 (i.e., arranged at a same electrical conductor 104), etc., depending on the implementation.

FIG. 3 illustrates a further example protection device 100 having an insulator 106 formed as a flexible strip having multiple layers 106a, 106b. FIG. 3 is a partial view of the protection device 100, showing one of the electrical conductors 104 and part of the fuse 102.

In one example, the layers 106a, 106b are made from the same material. Such a material may have electrically insulating and resilient properties (e.g., a high bending elasticity), as well as preferably a resistance to high temperatures. Therefore, the number of layers 106a, 106b can be chosen depending on a desired insulation, resilience, and/or temperature tolerance.

In another example, the layers 106a, 106b are each formed of a respective material. For example, layer 106a may be made from a material with enhanced electrically insulating properties but poor (er) resilience. Layer 106b may then be made from a material with enhanced resilient properties but poor (er) electrical insulation. It will be appreciated that, together, the insulator 106 may be configured (i.e., tailored) to have the overall properties desired for the protection device 100 according to the implementation.

The layers 106a, 106b may be attached by any suitable means, such as being integrally formed via a molding process, or via some adhesive, or the like. Further, it will be appreciated that any number of layers 106a, 106b may be added (e.g., as part of the manufacture of the protection device 100 or as a retrofitting step) to further modify the overall properties of the insulator 106.

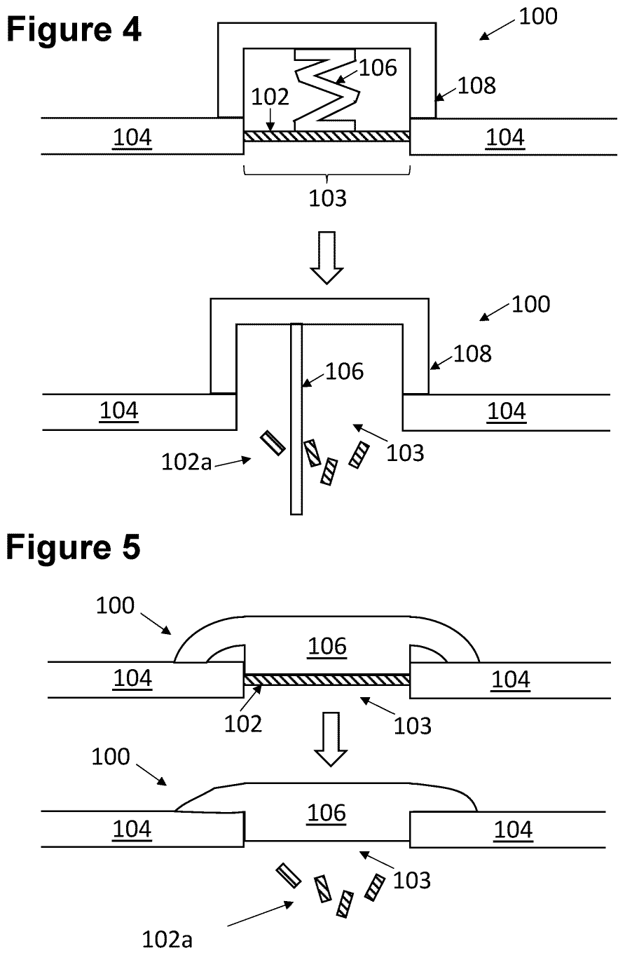

FIG. 4 shows an alternative arrangement for an insulator 106 and an insulator mount 108 in another example protection device 100. According to the illustrated example, the mount 108 is formed as a bridge or arch spanning the space 103. The insulator 106 is formed as a coiled or folded (e.g., in a concertina fashion) strip or wire which is held in its biased state by the fuse 102 and, in said biased state, is biased towards the space 103 between the electrical conductors 104.

In the event of an overcurrent, the insulator 106 may assist in detaching the weakened fuse 102a (which may have narrowed end regions to aid in such detaching) from the electrical conductors 104. The insulator 106 then extends between the electrical conductors 104 to inhibit the formation and/or persistence of electrical arcs therebetween. By abutting the center of the fuse 102, a detachment thereof (when weakened) from the electrical conductors 104 may advantageously be made more reliable, as a greater force moment is applied to the fuse 102.

FIG. 5 shows an alternative arrangement for an insulator 106 in another example protection device 100, wherein no mount 108 is required. According to this example, the insulator 106 is formed as a plug having attachment wings, each of which is attached to a respective electrical conductor 104. In its biased state, the insulator 106 may be biased by the attachment wings toward the space 103 between the electrical conductors 104.

When an overcurrent passes through the fuse 102, it is weakened and may fracture. According to the illustrated example of FIG. 5, the plug of the insulator 106 substantially spans the space 103 and thereby effectively and quickly removes the fuse material 102a from the space 103, and then occupies said space 103. Put another way, it can be seen that the insulator 106 according to this example is configured to remove at least a portion of the weakened fuse 102a from the space 103 between the electrical conductors 104 when moving from its biased state to its relaxed state.

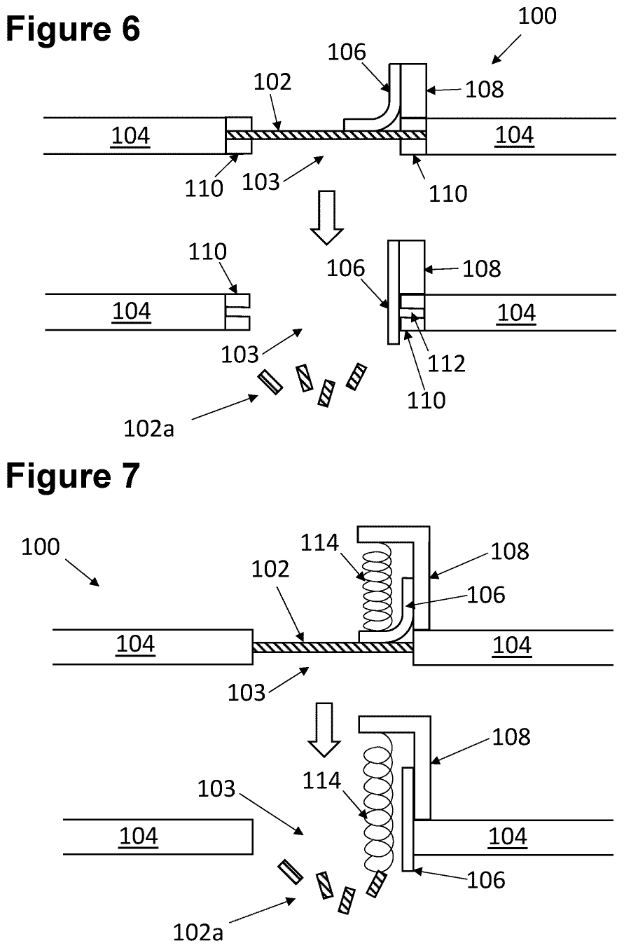

FIG. 6 shows an alternative configuration of the electrical conductors 104 in another example protection device 100. As shown in this figure, the ends of the electrical conductors 104 proximate to the space 103 between the electrical conductors 104 have an insulating covering 110. The insulating covering 110 may be made of a same material or a different material to that out of which the insulator 106 is formed.

According to this example, the fuse 102 passes through an opening 112 in the insulating covering 110, and the insulator 106 is configured to, in the relaxed state (shown in the lower part of FIG. 6), cover said opening 112 in the insulating covering 110.

Thus, it will be appreciated that the distance between electrically exposed parts of the electrical conductors 104 is increased by the application of the insulating coating 110. The possibility of an electrical arc forming and persisting between the electrical conductors 104 is therefore advantageously further mitigated. Indeed, it can be seen from the lower portion of FIG. 6 that, when the insulator 106 is in its relaxed state, the electrical conductor 106 at which it is arranged presents an entirely insulated face, and the insulator 106 substantially obstructs potential paths that an electrical arc could take between the closest exposed conductive surfaces of the electrical conductors 104.

FIG. 7 shows a further example protection device 100 with an additional further resilient member 114. According to this illustrated example, the further resilient member 114 is a spring attached to the same mount 108 as the insulator 106. The spring 114 is arranged to provide additional force onto the insulator 106 to further bias the insulator 106 toward the space 103 between the electrical conductors 104.

According to such an example, the combined force of the further resilient member 114 and the insulator 106, being itself formed as a resilient member, may more reliably ensure that the fuse 102 is removed when an overcurrent passes therethrough and/or that the weakened fuse 102a is readily removed from the space 103 between the electrical conductors 104.

In this example, the spring 114 may preferably be formed of metal, in particular aluminum oxide (AIO) which retains its elastic properties even at the higher temperatures that may occur during an overcurrent through the fuse 102. However, it will be appreciated that the spring 114 may be formed of any suitable material depending on the implementation, and that an alternative or additional further resilient member 114 may be provided.

It will be further appreciated that, to mitigate any arcing caused by the presence of a conductive further resilient member 114, an additional insulator may be positioned either side thereof (e.g., from a far-left side of the mount 108 as shown in FIG. 7), or the further resilient member 114 may be coated with an insulating coating.

Furthermore, it will be appreciated that, in some examples, a pulling force is applied to the fuse 102 instead of or in addition to a pushing force. That is, the fuse 102 may be pulled from above or below (e.g., from a central position) by, for example, the additional resilient element 114 anchored on a mount 108, such that, when the fuse 102 is weakened by an overcurrent (e.g., partially melted at the ends), the fuse 102 is rapidly pulled from the space 103 between the electrical conductors 104.

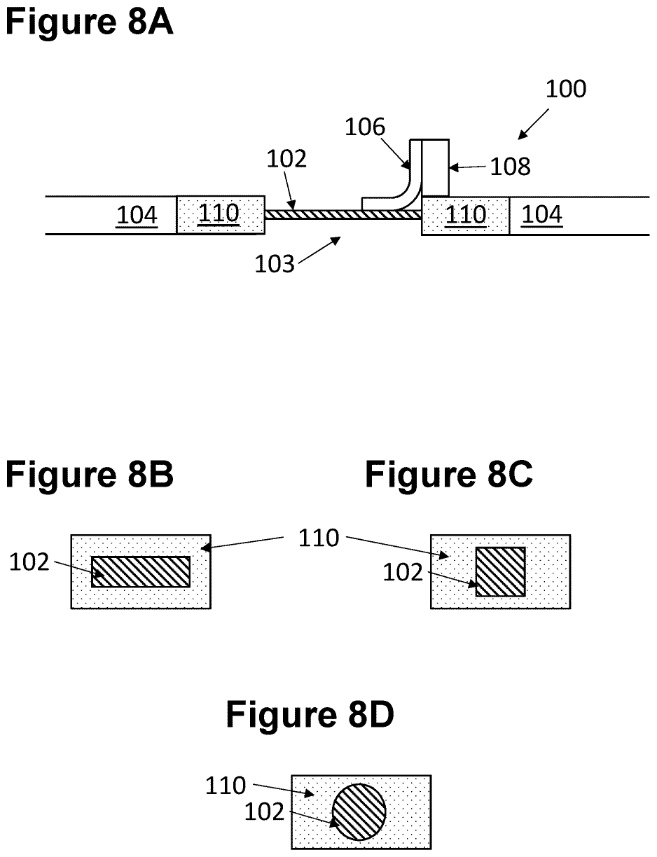

FIGS. 8A-D show an example protection device similar to that shown in FIG. 6, wherein the insulating covering 110 extends further along the electrical conductors 104. As shown in FIGS. 8B-D, the surface of the conductors 104 at their closest approach is covered in the insulating covering 110, apart from the entry of the fuse 102.

FIG. 8B shows an example wherein the cross-section of the fuse is an extended rectangle, FIG. 8C shows an example wherein the cross-section of the fuse is a square, and FIG. 8D shows an example wherein the cross-section of the fuse is a circle. In these latter two illustrated examples, it can be seen that a thinner insulator 106 can be used to completely cover the hole left by the fuse 102 when it is blown.

The electrical conductors 104 have their closest approach to each other bridged by the fuse 102 and a substantial end portion covered in the insulating covering 110. Hence, it can be seen that the closest exposed/conductive surfaces of the electrical conductors 104 are substantially spaced apart. Thus, when the insulator 102 of the protection device 100 is in the relaxed state, the system can be rendered safe and can remain so for an indefinite time thereafter.

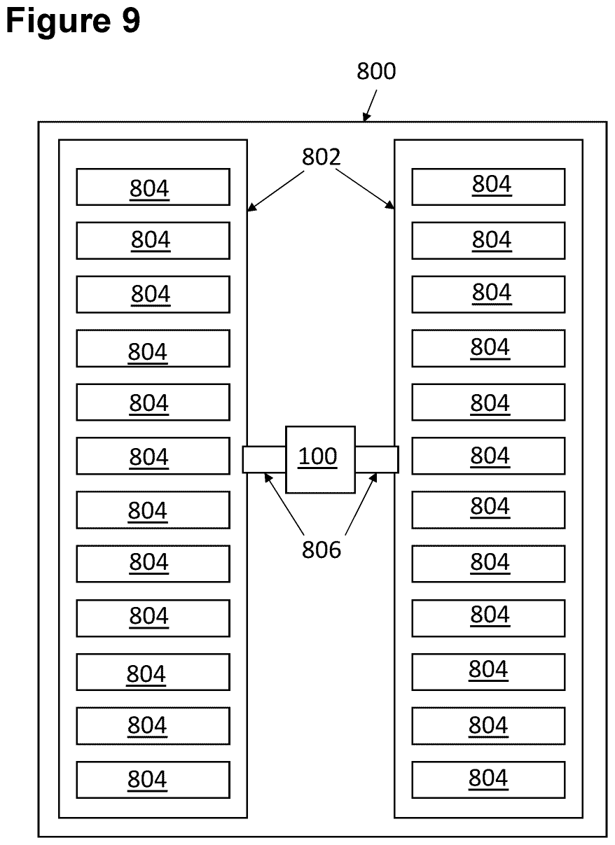

FIG. 9 shows an example implementation of the protection device 100 such as that described above in relation to the previous figures. There is shown in the illustrated example a battery pack 800 comprising a plurality of battery modules 802 (or simply ‘modules 802’). Each battery module 802 comprises a plurality of cells 804. The cells 804 are shown as being prismatic cells having a rectangular profile, but it will be appreciated that any other form factor of cell may be used, depending on the implementation.

Although not shown, the cells 804 may be electrically connected in series and/or in parallel to combine electrical energy stored therein. The modules 802 may then be connected to each other via conductors 806 having a protection device 100 arranged thereon. It will be appreciated that such a modular design for a battery pack 800 is preferable in respect of energy density, safety, and simplicity, especially in the context of an automotive application, an electrical energy storage system, or the like. However, the greater the number of cells 804 per module 802, the greater the stress placed on the protection device 100.

Therefore, the protection device 100 described herein may advantageously allow for an increase in the possible voltage per module 802 without an associated risk of arcing between the conductors 806. As such, an improved battery pack 800, e.g., having greater energy density or safe and reliable operation, is provided as a result of the installation of such a protection device 100.

While the present disclosure is susceptible to various modifications and alternative forms, specific examples are shown and described in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims, including the possible combination of various elements of these specific examples.

1. A protection device for a battery pack, comprising:
a fuse arranged in a space between electrical conductors and configured to weaken when an overcurrent passes therethrough; and
an insulator formed as a resilient member having a biased state and a relaxed state;
wherein:
the insulator is held in the biased state by the fuse, and
the insulator is biased towards the space between the electrical conductors in the biased state.

2. The protection device according to claim 1, wherein the fuse comprises a fuse element configured to melt or fracture when an overcurrent passes therethrough.

3. The protection device according to claim 1, wherein the insulator is formed as a flexible strip.

4. The protection device according to claim 3, wherein a first end of the flexible strip is fixed to a first electrical conductor of the electrical conductors and a second end of the flexible strip is biased towards the first end by the fuse to thereby hold the insulator in the biased state.

5. The protection device according to claim 3, wherein the flexible strip comprises a plurality of layers.

6. The protection device according to claim 1, further comprising a second insulator formed as a resilient member having a biased state and a relaxed state, wherein the second insulator is held in the biased state by the fuse, and the second insulator is biased towards the space between the electrical conductors in the biased state.

7. The protection device according to claim 6, wherein the insulator is arranged at a first electrical conductor of the electrical conductors and the second insulator is arranged at a second electrical conductor of the electrical conductors.

8. The protection device according to claim 7, wherein the insulator is biased in a first direction towards the space between the electrical conductors, and the second insulator is biased in a second direction towards the space, the second direction being at least partially opposite the first direction.

9. The protection device according to claim 1, wherein the insulator is configured to remove at least a portion of the weakened fuse from the space between the electrical conductors when moving from the biased state to the relaxed state.

10. The protection device according to claim 1, wherein an end of at least one of the electrical conductors proximate to the space between the electrical conductors has an insulating covering.

11. The protection device according to claim 10, wherein the fuse passes through an opening in the insulating covering, and the insulator is configured to, in the relaxed state, cover said opening in the insulating covering.

12. The protection device according to claim 1, further comprising a further resilient member configured to additionally bias the insulator towards the space between the electrical conductors.

13. The protection device according to claim 12, wherein the further resilient member comprises a spring.

14. The protection device according to claim 13, wherein the spring is substantially formed of aluminum oxide.

15. A battery pack comprising:
at least two battery modules; and
the protection device according to any preceding claim,
wherein the electrical conductors and the fuse form an electrical interconnection between the at least two modules.

16. The protection device according to claim 2, wherein the insulator is formed as a flexible strip.

17. The protection device according to claim 4, wherein the flexible strip comprises a plurality of layers.
